(19) United States
(12) Patent Application Publication
(10) Pub. No.: US 2019/0333118 A1
(43) Pub. Date: Oct. 31, 2019

(54) COGNITIVE PRODUCT AND SERVICE RATING GENERATION VIA PASSIVE COLLECTION OF USER FEEDBACK

(71) Applicant: International Business Machines Corporation, Armonk, NY (US)

(72) Inventors: Andrew G. Crimmins, Montrose, NY (US); Pasquale A. Catalano, Wallkill, NY (US); John S. Werner, Fishkill, NY (US); Arkadiy O. Tsfasman, Wappingers Falls, NY (US)

(21) Appl. No.: 15/964,436

(22) Filed: Apr. 27, 2018

(51) Int. Cl. G06Q 30/02; G06F 17/27; G10L 15/26; G10L 15/18; G06F 15/18

(52) U.S. Cl. CPC G06Q 30/0282; G06F 17/2705; H04L 51/32; G10L 15/1815; G06F 15/18; G10L 15/265

(57) ABSTRACT

A computer implemented method is provided for automatically generating a user review of an item without requiring user action. A user's purchase of an item is recognized. A list of keywords associated with the item is generated. A series of predetermined time periods for the item is set. Communication data of the user is passively collected. An occurrence of at least one keyword of the list of keywords is detected in the communication data. Sentiment analysis is performed on at least one portion of the communication data. A review of the item is generated or updated at each time period of the series of predetermined time periods, in which the review of a given time period includes a rating score for the given time period and an overall rating score for the series of predetermined time periods.

### BACKGROUND

The present invention generally relates to automatic rating generation for a product or service, and more specifically, to cognitive systems for product and rating generation via passive collection of user feedback.

Known systems assist in the automatic generation of an overall review for a product or service that is purchased by a user. Those systems rely on obtaining direct feedback from users of the product or service, such as by receiving a survey that is answered by a user regarding the user's experience with a certain product or service. However, known systems are prone to generating inaccurate overall user reviews as some users tend to only provide reviews when their opinion of a product or service is extremely positive or extremely negative. Moreover, some users choose to not provide reviews altogether irrespective of how strongly or negatively they feel about a given product or service. By relying on obtaining only direct user feedback regarding a purchase or service, known systems are prone to generating inaccurate overall scores for a product or service because those systems limit the sample size of received user feedback to only a subset of purchasing or consuming users and received feedback is biased to a positive or negative extreme.

As used herein, the phrase “machine learning” broadly describes a function of an electronic system that learns from data. A machine learning system, engine, or module can include a trainable machine learning algorithm that can be trained, such as in an external cloud environment, to learn functional relationships between inputs and outputs that are currently unknown.

As used interchangeably herein, the phrases “product or service” and “item” broadly refer to any tangible or intangible good or service that can be purchased and/or consumed by a user.

### SUMMARY

Embodiments of the present invention provide a computer-implemented method for automatically generating a user review of an item without requiring user action. A non-limiting example of the computer-implemented method includes recognizing that a user purchased an item. The method includes, after recognizing that the user purchased the item, generating a list of keywords associated with the item for recognizing when the user is passively providing feedback regarding the item. The method includes setting a series of predetermined time periods for the item, which may vary in frequency and/or total count based on the type of item under review, in which each time period of the series of predetermined time periods represents a different respective length of ownership of the item. The method includes passively collecting communication data of the user that is generated during each time period of the series of predetermined time periods. The method includes detecting an occurrence of at least one keyword of the list of keywords in the communication data of each time period of the series of predetermined time periods. The method includes performing sentiment analysis on at least one portion of the communication data of each time period of the series of predetermined time periods. The method includes generating or updating a review of the item at each time period of the series of predetermined time periods. The generating or updating of the review of the item of a given time period of the series of predetermined time periods includes generating a rating score for the given time period based on the sentiment analysis and then generating or updating an overall rating score for the series of predetermined time periods based on the rating score of the given time period. In some embodiments of the present invention, the method further includes generating “indifferent” or “neutral” reviews in cases where no occurrences of any of the keywords of the list of keywords are detected in the communication data of each time period of the series of predetermined time periods.

Embodiments of the present invention provide to a system for automatically generating a user review of an item without requiring user action, in which the system includes one or more processors configured to perform a method. A non-limiting example of the computer-implemented method includes recognizing that a user purchased an item. The method includes, after recognizing that the user purchased the item, generating a list of keywords associated with the item for recognizing when the user is passively providing feedback regarding the item. The method includes setting a series of predetermined time periods for the item, which may vary in frequency and/or total count based on the type of item under review, in which each time period of the series of predetermined time periods represents a different respective length of ownership of the item. The method includes passively collecting communication data of the user that is generated during each time period of the series of predetermined time periods. The method includes detecting an occurrence of at least one keyword of the list of keywords in the communication data of each time period of the series of predetermined time periods. The method includes performing sentiment analysis on at least one portion of the communication data of each time period of the series of predetermined time periods. The method includes generating or updating a review of the item at each time period of the series of predetermined time periods. The generating or updating of the review of the item of a given time period of the series of predetermined time periods includes generating a rating score for the given time period based on the sentiment analysis and then generating or updating an overall rating score for the series of predetermined time periods based on the rating score of the given time period. In some embodiments of the present invention, the method further includes generating “indifferent” or “neutral” reviews in cases where no occurrences of any of the keywords of the list of keywords are detected in the communication data of each time period of the series of predetermined time periods.

Embodiments of the invention provide a computer program product for automatically generating a user review of a product or service without requiring user action, the computer program product comprising a computer readable storage medium having program instructions embodied therewith. The program instructions are executable by a system having one or more processors to cause the system to perform a method. A non-limiting example of the computer-implemented method includes recognizing that a user purchased an item. The method includes, after recognizing that the user purchased the item, generating a list of keywords associated with the item for recognizing when the user is passively providing feedback regarding the item. The method includes setting a series of predetermined time periods for the item, which may vary in frequency and/or total count based on the type of item under review, in which each time period of the series of predetermined time periods represents a different respective length of ownership of the item. The method includes passively collecting communication data of the user that is generated during each time period of the series of predetermined time periods. The method includes detecting an occurrence of at least one keyword of the list of keywords in the communication data of each time period of the series of predetermined time periods. The method includes performing sentiment analysis on at least one portion of the communication data of each time period of the series of predetermined time periods. The method includes generating or updating a review of the item at each time period of the series of predetermined time periods. The generating or updating of the review of the item of a given time period of the series of predetermined time periods includes generating a rating score for the given time period based on the sentiment analysis and then generating or updating an overall rating score for the series of predetermined time periods based on the rating score of the given time period. In some embodiments of the present invention, the method further includes generating “indifferent” or “neutral” reviews in cases where no occurrences of any of the keywords of the list of keywords are detected in the communication data of each time period of the series of predetermined time periods.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 depicts an exemplary computer system capable of implementing one or more embodiments of the present invention;

FIG. 4 depicts an exemplary system that facilitates review generating via passive collection of communication data in accordance with one or more embodiments of the present invention;

FIG. 5 depicts an example process flow that can be implemented by the system of FIG. 4 in accordance with one or more embodiments the present disclosure; and

FIG. 6 depicts a flow diagram illustrating an example methodology in accordance with one or more embodiments of the present invention.

The diagrams depicted herein are illustrative. There can be many variations to the diagram or the operations described therein without departing from the spirit of the invention. For instance, the actions can be performed in a differing order or actions can be added, deleted, or modified. Also, the term “coupled” and variations thereof describes having a communications path between two elements and does not imply a direct connection between the elements with no intervening elements/connections between them. All of these variations are considered a part of the specification.

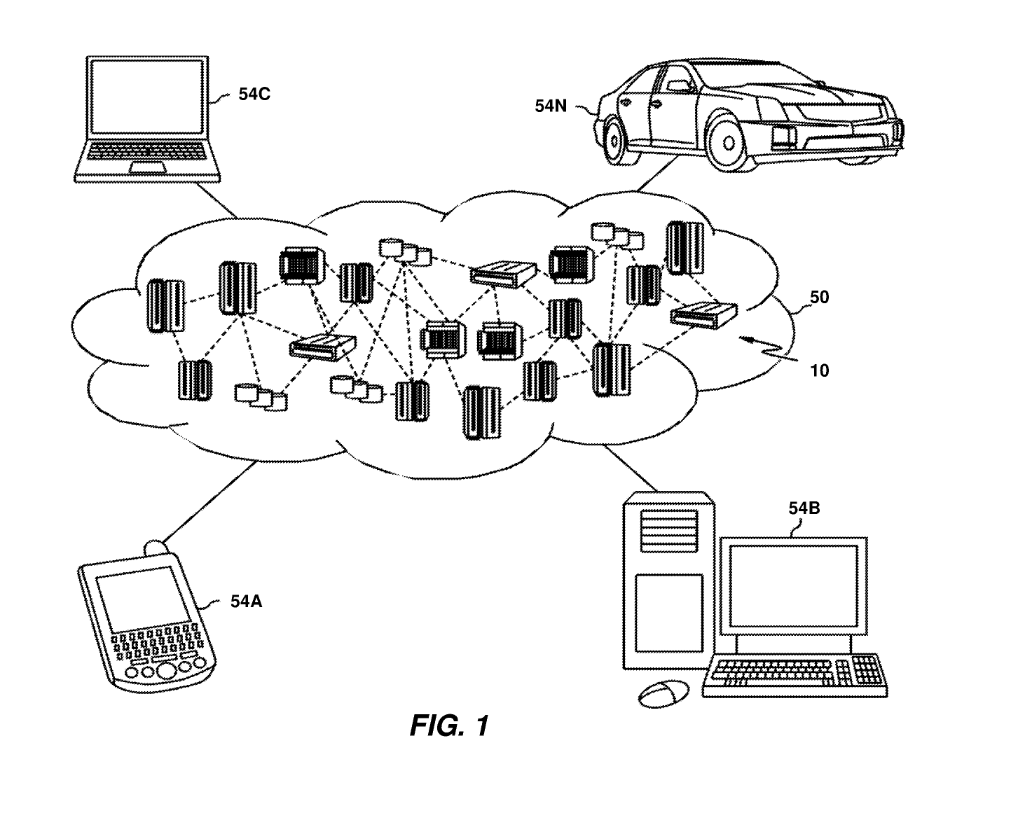

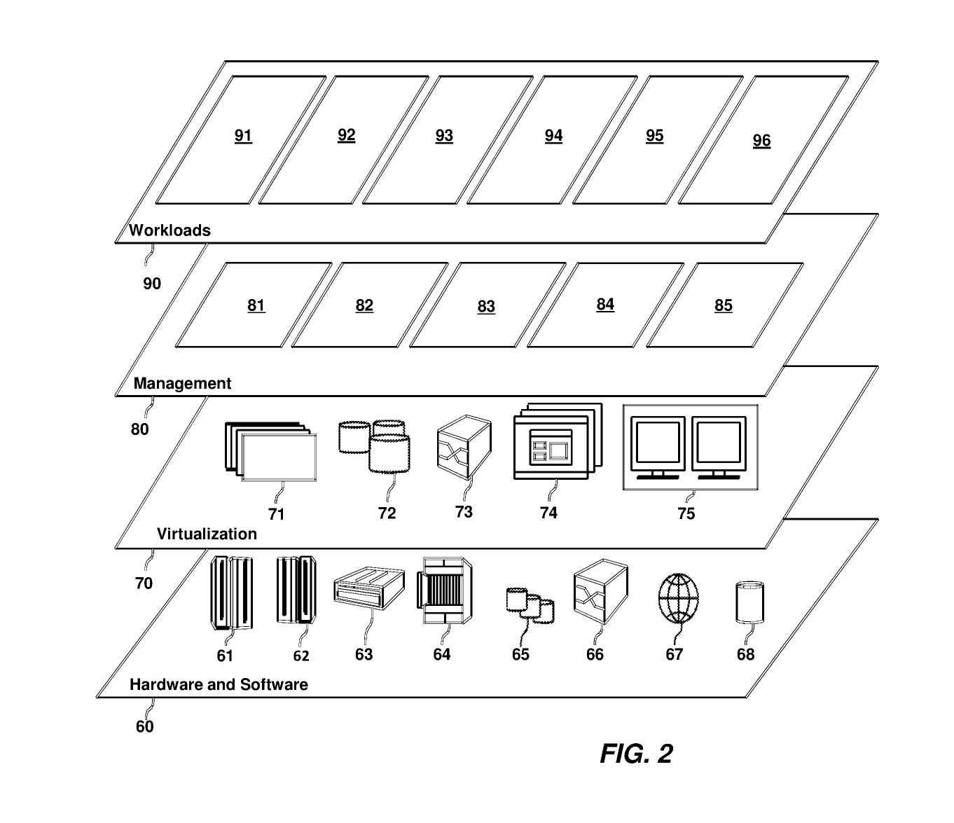

In the accompanying figures and following detailed description of the disclosed embodiments, the various elements illustrated in the figures are provided with two-digit or three-digit reference numbers. With minor exceptions (e.g., FIGS. 1-2), the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e., two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems; storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and review generation processing 96.

Turning now to an overview of technologies that are more specifically relevant to aspects of the invention, some systems allow a user to provide direct feedback on products and/or services that they have purchased, consumed, and/or otherwise used. This type of direct user feedback is often utilized by other purchasers of the same product or service or similar types of products and/or services to influence their purchasing and/or consumption decisions. For example, some people tend to rely on online user reviews before making a purchasing decision of a product or service, or deciding to consume or view certain content (e.g., a purchase of electronics, deciding whether to start watching a new TV series on a streaming platform, starting a new health supplement or workout routine, etc.).

As noted above, known systems assist in generating an overall review of a product or service by obtaining direct feedback from users of the product or service. For example, known systems may be configured to send a survey to a user, which asks what user's opinion is regarding a certain product or service. However, known systems are prone to generating inaccurate overall user reviews as some users tend to only provide reviews when their opinion of a product or service is extremely positive or extremely negative. Moreover, some users choose to not provide reviews altogether irrespective of how strongly or negatively they feel about a given product or service, due in part to action being required by the user in order to fill out and generate the review. By relying on obtaining only direct user feedback regarding a purchase or service, known systems are prone to generating inaccurate overall scores of a product or service because: (a) a significant number of users who purchase the product or service do not provide feedback, thereby limiting the sample size of user feedback to only a subset of purchasing or consuming users, and (b) the user provided feedback tends to pertain to only very positive or negative opinions, thereby causing the overall review of the product be biased to a positive or negative extreme.

Reviews provided by users for a given product or service are often associated with a particular length of ownership of the product or service. This type of length of ownership information is sometimes used in online product review platforms to assist a reader's understanding of how much expertise a particular reviewer may have regarding a given product or service. For example, if a reviewer has only owned the product for a short amount of time, a reader may choose to not trust a negative review of the reviewer as the reviewer might not fully understand how to use the product by the time the review was provided.

Turning now to an overview of the aspects of the invention, one or more embodiments of the present invention address the above-described shortcomings of the prior art by providing a cognitive-based tool for generating product and/or service reviews via passive collection of user feedback without requiring an explicit action by a user (e.g. requiring a user to provide direct feedback to a review generation system). The cognitive-based tool is able to generate more accurate scores in comparison to prior systems because the scores that are generated by the cognitive-based tool are based on a larger, and less biased, knowledgebase of user feedback data as compared to the knowledgebase used by prior systems. One or more embodiments of the present invention rely on the passive collection of user feedback rather than requiring users to provide explicit feedback regarding a particular product or service.

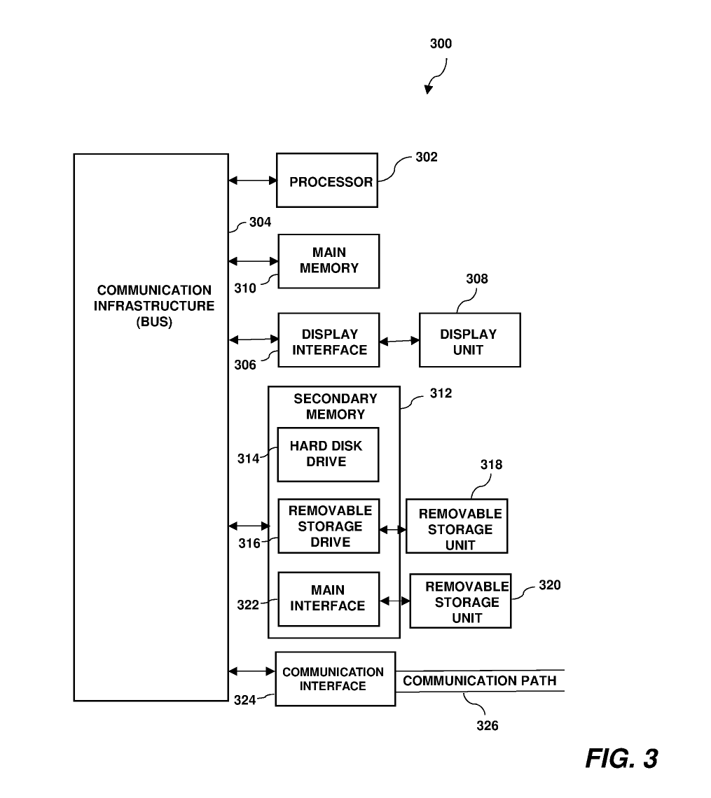

Turning now to a more detailed description of aspects of the present invention, FIG. 3 illustrates a high-level block diagram showing an example of a computer-based system 300 useful for implementing one or more embodiments of the invention. Although one exemplary computer system 300 is shown, computer system 300 includes a communication path 326, which connects computer system 300 to additional systems and may include one or more wide area networks (WANs) and/or local area networks (LANs) such as the internet, intranet(s), and/or wireless communication network(s). Computer system 300 and additional systems are in communication via communication path 326, (e.g., to communicate data between them).

Computer system 300 includes one or more processors, such as processor 302. Processor 302 is connected to a communication infrastructure 304 (e.g., a communications bus, cross-over bar, or network). Computer system 300 can include a display interface 306 that forwards graphics, text, and other data from communication infrastructure 304 (or from a frame buffer not shown) for display on a display unit 308. Computer system 300 also includes a main memory 310, preferably random access memory (RAM), and may also include a secondary memory 312. Secondary memory 312 may include, for example, a hard disk drive 314 and/or a removable storage drive 316, representing, for example, a floppy disk drive, a magnetic tape drive, or an optical disk drive. Removable storage drive 316 reads from and/or writes to a removable storage unit 318 in a manner well known to those having ordinary skill in the art. Removable storage unit 318 represents, for example, a floppy disk, a compact disc, a magnetic tape, or an optical disk, etc., which is read by and written to by removable storage drive 316. As will be appreciated, removable storage unit 318 includes a computer readable medium having stored therein computer software and/or data.

In some alternative embodiments of the invention, secondary memory 312 may include other similar means for allowing computer programs or other instructions to be loaded into the computer system. Such means may include, for example, a removable storage unit 320 and an interface 322. Examples of such means may include a program package and package interface (such as that found in video game devices), a removable memory chip (such as an EPROM or PROM) and associated socket, and other removable storage units 320 and interfaces 322 which allow software and data to be transferred from the removable storage unit 320 to computer system 300.

Computer system 300 may also include a communications interface 324. Communications interface 324 allows software and data to be transferred between the computer system and external devices. Examples of communications interface 324 may include a modem, a network interface (such as an Ethernet card), a communications port, or a PCM-CIA slot and card, etc. Software and data transferred via communications interface 324 are in the form of signals which may be, for example, electronic, electromagnetic, optical, or other signals capable of being received by communications interface 324. These signals are provided to communications interface 324 via communication path (i.e., channel) 326. Communication path 326 carries signals and may be implemented using wire or cable, fiber optics, a phone line, a cellular phone link, an RF link, and/or other communications channels.

In the present disclosure, the terms “computer program medium,” “computer usable medium,” and “computer readable medium” are used to generally refer to media such as main memory 310 and secondary memory 312, removable storage drive 316, and a hard disk installed in hard disk drive 314. Computer programs (also called computer control logic) are stored in main memory 310, and/or secondary memory 312. Computer programs may also be received via communications interface 324. Such computer programs, when run, enable the computer system to perform the features of the present disclosure as discussed herein. In particular, the computer programs, when run, enable processor 302 to perform the features of the computer system. Accordingly, such computer programs represent controllers of the computer system.

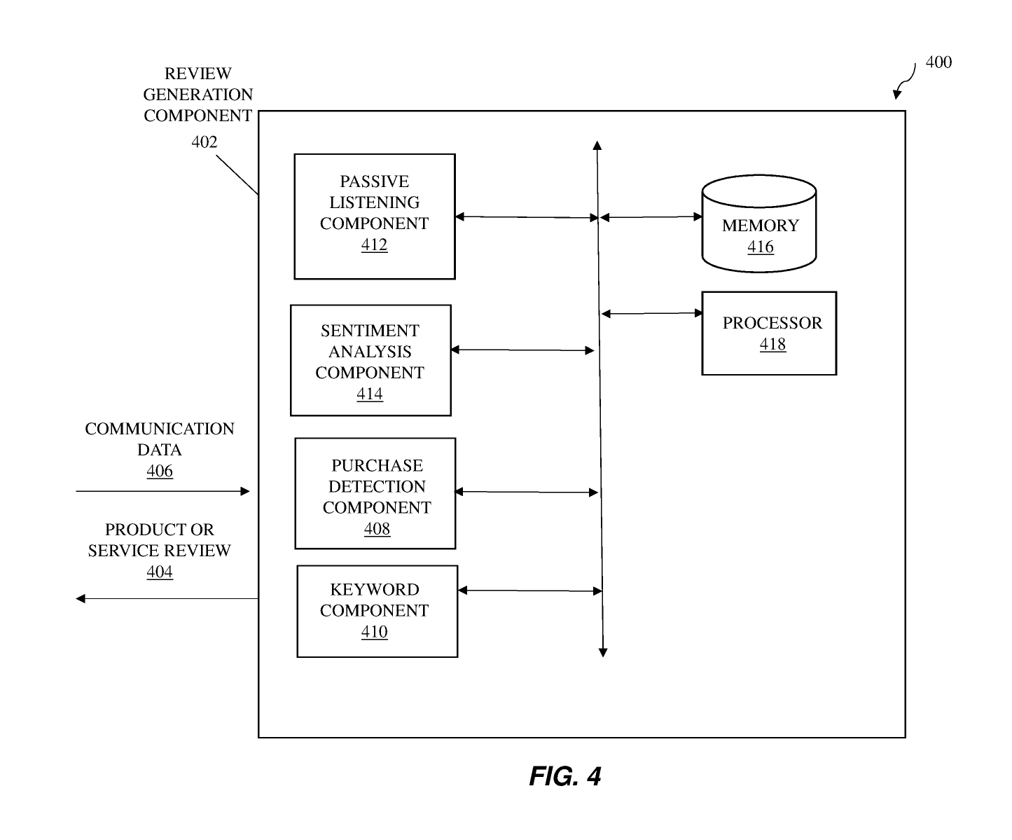

FIG. 4 depicts an example computer system 400 capable of implementing one or more embodiments of the present invention in accordance with one or more embodiments of the present invention. System 400 is a machine learning system that can be utilized to solve a variety of technical issues (e.g., learning previously unknown functional relationships) in connection with technologies such as, but not limited to, machine learning technologies, data analytics technologies, data classification technologies, data clustering technologies, recommendation system technologies, signal processing technologies, manufacturing defect and analysis technologies, and/or other digital technologies. System 400 employs hardware and/or software to solve problems that are highly technical in nature, that are not abstract and that cannot be performed as a set of mental acts by a human. In some embodiments of the present invention, some or all of the processes performed by system 400 are performed by one or more specialized computers (e.g., one or more specialized processing units, a specialized computer with a review generation component, etc.) for carrying out defined tasks related to machine learning. In some embodiments of the invention, system 400 and/or components of the system are employed to solve new problems that arise through advancements in technologies mentioned above.

In general, system 400 includes a review generation component 402 that is configured to generate one or more product and/or service reviews via a passive collection of user feedback without requiring an explicit action by a user (e.g. requiring a user to provide direct feedback to a recommendation system). For example, in some embodiments of the present invention, review generation component 402 is configured to establish communication with a computing device associated with a user, register the user with review generation component 402 to obtain consent, recognize when the registered user makes a new purchase of a product or service, passively collect communication data 406 pertaining to the user over time as the user goes about their day (e.g., recording mobile device audio, social media postings, email, text messages, etc.), detected one or more keywords in the communication data 406 that indicate that the registered user is presently discussing the recognized product or service, and then parse and/or record one or more portions of the communication data 406 based on the detection of the one or more keywords. Review generation component 402 then applies one or more machine learning algorithms to one or more portion of the communication data 406. For example, in some embodiments of the present invention, the application of the one or more machine learning algorithms includes performing sentiment analysis, visual recognition processing, natural language processing, and/or tone recognition processing on at least a portion of the communication data to ascertain how the user feels about the product or service (e.g., positive, negative, indifferent). The sentiment analysis takes into consideration the length of ownership of the particular type of product or service that was purchased. A product or service review 404 is then generated and/or updated by review generation component 402. Some suitable non-limiting examples of the machine learning algorithms that can be used within the context of one or more embodiments of the present invention include Natural Language Understanding API, Tone Analyzer API, Visual Recognition API and/or Natural Language Classifier API provided by IBM Watson®. Other suitable cognitive based algorithms or techniques may be used such that a nature of a conversation or text found in communication data 406 may be ascertained.

Machine learning is often employed by numerous technologies to determine inferences and/or relationships among digital data. For example, machine learning technologies, signal processing technologies, image processing technologies, data analysis technologies, and/or other technologies employ machine learning models to analyze digital data, process digital data, determine inferences from digital data, and/or determine relationships among digital data. Machine learning functionality can be implemented using an artificial neural network (ANN) having the capability to be trained to perform a currently unknown function. In machine learning and cognitive science, ANNs are a family of statistical learning models inspired by the biological neural networks of animals, and in particular the brain. ANNs can be used to estimate or approximate systems and functions that depend on a large number of inputs.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was read.

In the example shown in FIG. 4, review generation component 402 of system 400 includes a purchase detection component 408, a keyword component 410, a passive listening component 412, and a sentiment analysis component 414. In some embodiments of the invention, review generation component 402 constitutes machine-executable component(s) embodied within machine(s) (e.g., embodied in one or more computer readable mediums (or media) associated with one or more machines). Such component(s), when executed by the one or more machines, (e.g., computer(s), computing device(s), virtual machine(s), etc.) cause the machine(s) to perform the operations described. In some embodiments of the invention, review generation component 402 includes a memory 416 that stores computer executable components and instructions. Furthermore, review generation component 402 in some embodiments of the invention includes a processor 418 to facilitate execution of the instructions (e.g., computer executable components and corresponding instructions) by the review generation component 402. As shown, the purchase detection component 408, the keyword component 410, the passive listening component 412, the sentiment analysis component 414, the memory 416, and/or the processor 418 are electrically and/or communicatively coupled to one another in one or more embodiments of the invention.

As noted above, in some embodiments of the present invention review generation component 402 is configured to register a user with system 400 to obtain consent from the user to participate in the passive collection of communication data 406 pertaining to the user. Once registered, review generation component 402 (e.g., via purchase detection component 408) is configured to recognize and identify products and/or services that are newly purchased by the registered user. In some embodiments of the present invention, the recognizing and identifying of products and/or services are performed by, for example, review generation component 402 parsing a website shopping cart that is accessed by the registered user during a transaction, parsing receipts emailed to the registered user, parsing credit card statements emailed to the registered user, and/or parsing social media posts of the registered user where the user mentions making a purchase of a product or service such as, for example, purchasing a car. In some embodiments of the present invention, the parsing is performed by monitoring activity of a computing device associated with the user via a software application executed on the computing device such that actions that are performed on the computing device are recorded, in which the software application causes the computing device to transmit an indication to review generation component 402 when a new purchase or consumption of a product or service is detected. Other suitable manners of recognizing when a user has purchased a particular product or service may be utilized in one or more embodiments of the present invention, such as for example, crawling a plurality of websites to obtain a purchase history of the registered user.

In response to detecting that the registered user has recently purchased or consumed a particular product or service, review generation component 402 then generates a list of keywords that are associated with the particular product or service (e.g., via keyword component 410), in which the keywords are used to detect when the registered user is discussing the recognized product or service detect in the received communication data 406. For example, in some embodiments of the present invention, after review generation component 402 recognizes that the registered user recently purchased a product or service, keyword component 410 would then generate a list of keywords to be used by passive listening component 412 to detect when the registered user mentions or describes the recognized purchased product or service.

In some embodiments of the present invention, the generated list of keywords includes one or more default keywords. For example, if review generation component 402 detects that a registered user purchased a car, in some embodiments of the present invention keyword component 410 would then generate a list of keywords that includes the words “car”, “new car”, “truck”, “dealership”, “lease”, “tires”, and/or “four wheel drive”, etc. In some embodiments of the present invention, the generated list of keywords further or alternatively includes words that are indicative of the specific type of product or service that was purchased such as, for example, the name of the model or manufacturer of a purchased car. In some embodiments of the present invention, the generated list of generated keywords further or alternatively includes words that are indicative of specific features that are known to be associated with a purchased product or service such as, for example, the name of specific features that are known to be included in standard models of the purchased car. In some embodiments of the present invention, the generated list of generated keywords further or alternatively include words that are mentioned in a purchase receipt of the product or service such as, for example, words that are found in a purchase receipt of a car, in which words are extracted from the purchase receipt by parsing the receipt (e.g., via purchase detection component 408).

Review generation component 402 is configured to set a series of predetermined time periods for the recognized product or service, in which each time period of the series of predetermined time periods reflects a different stage of ownership or consumption of the product or service. The series is set based on the specific type of product or service that was purchased and/or consumed. By setting a series of predetermined time periods, review generation component 402 is able to generate a review for the product or service based on communication data that is obtained between certain points in time after the user purchased and/or consumed a product or service. For example, in some embodiments of the present invention, review generation component 402 is configured to generate, for a given purchased product or service, a series of predetermined time periods that includes one or more time periods, in which each time period represents a particular respective length of ownership of the purchased product or service, in which the series is set based on the type of product or service that was purchased by the user. For example, in some embodiments of the present invention, review generation component 402 is configured to identify which series of a plurality of series is associated with a particular type of purchased product or service and then to set the series based on the identified associated series, in which the plurality of series includes a first series of predetermined time periods that is associated with a first particular type of product or service and a second series of predetermined time periods that is associated with a second different type of product or service. In some embodiment of the present invention, review generation component 402 is configured to query a database comprising a plurality of types of product or services, in which each type of product or service is associated with a particular series of predetermined time periods in the database. In some embodiments of the present invention, a series of predetermined time periods includes only one time period such as, for example, a time period that spans from the time of purchase of a product to a certain end date associated with the type of product or service. In some embodiments of the present invention, the end date is established based on an expected lifecycle of the type of product or service.

In some embodiments of the present invention, each time period of the series of predetermined time periods represents a predetermined amount of time (e.g., seconds, minutes, hours, days, weeks, years, etc.) between a certain start time and a certain end time. In some embodiments of the present invention, review generation component 402 may set a series of predetermined time periods that includes a first time period and a second time period, in which the first time period spans from the time of purchase through a first date and/or time, and the second time period spans from the first date and/or time through a second date and/or time. For example, in the context of a purchase of a cellular phone, in some embodiments of the present invention review generation opponent 402 may set a series of time periods having a first and second time period, in which the first time period spans from the time of purchase of the cellular phone through one week from the time of purchase (i.e., the first date and/or time), in which the second time period spans from one week from the time of purchase of the cellular phone (i.e., the first date and/or time) through two years from the time of purchase (i.e., the second date and/or time). In this example, the first time period may be useful for generating an initial review of a cellular phone as the first time period spans a short timeframe from the time of purchase. The second time period may be useful for generating a review near the end of the product life cycle of the cellular phone, which assists in detecting whether a major flaw has been encountered with the product.

For some products or services, a user may not encounter a major flaw for many years, and thus a time period may be set in the series of predetermined time periods to account for such a time span. For example, in the context of a purchase of a heating furnace for a home, it is possible that it would be unlikely for a user to encounter a major flaw within the first 20 years of purchase. In some embodiments of the present invention, a time period may be set that spans from 20 years from the time of purchase through some second date, such as through 25 years from the time of purchase.

After the series of predetermined time periods are set, review generation component 402 then passively collects communication data 406 of the user during each given time period of the series of predetermined time periods, and detects occurrences of keywords in the communication data that was collected during the given time period. For example, in some embodiments of the present invention, the system passively collects audio data from a microphone of a mobile device of the user and then triggers an alert when the system detects that a particular service or product is being described or referenced by the user.

In some embodiments of the present invention, the communication data 406 of a given time period is obtained in real-time as the communication data 406 is being generated (i.e. obtaining audio data that is generated in real-time by a microphone of the computing device of the user during the given time period). In some embodiments of the present invention, the communication data 406 of a given time period is obtained subsequent to the time period occurring (obtaining audio data after the given time period occurs, in which the audio data was generated by a microphone of the computing device of the user during the given time period).

In some embodiments of the present invention, upon detecting a keyword in the communication data 406 of a given time period, review generation component 402 then starts recording or parsing a portion of the communication data 406. For example, in some embodiments of the present invention, review generation component 402 may record communication data 406 of the given time period (e.g. recording audio) or parse communication data 406 of the given time period (e.g., parsing text communication) for a preset amount of time from when the keyword is detected (e.g., recording two minutes of audio after a keyword is detected, parsing two minutes of text after a keyword is detected). In some embodiments of the present invention, if keywords keep coming up in communication data (e.g., audio or text data), the recording or parsing would continue. In some embodiments of the present invention, the recording and or parsing of the communication data 406 includes storing a time stamp that is indicative of when a particular keyword was detected.

In some embodiments of the present invention, if the communication content 406 includes audio data, review generation component 402 may extract text data from the obtained audio data by transcribing the audio data into text. For example, in some embodiments of the present invention, text data that includes spoken words or other sounds are extracted from an audio portion of the communication data 406 of the given period. In some embodiments of the present invention, the text data is extracted via a speech-to-text technique such as via a speech-to-text API. One example suitable API is the Speech to Text API provided by IBM Watson. Other suitable types of speech-to-text algorithms or APIs may be used that allow for speech-to-text translation of audio data.

The portions of communication data 406 of the given time period that were recorded or parsed for the present amount of time for the given time period (hereinafter “the captured portions”) are then transmitted to the sentiment analysis component 414.

Sentiment analysis component 414 is configured to perform sentiment analysis on the portions of the communication data 406 that were captured at each given time period of the series of predetermined time periods to ascertain how the user feels about the product of service (e.g., positive, negative, indifferent, etc.) at each given time period. In particular, in some embodiments of the present invention, sentiment analysis component 414 is configured to analyze the captured portions of the given time period to determine the nature of a conversation or text that is found within the captured portions of the given time. For example, in some embodiments of the present invention, this determination includes analyzing text data of the captured portions to extract one or more of a tone of spoken words, sentiment, mood, and/or intensity of one or more speakers. In some embodiments of the present invention, the determination is achieved by application of one or more machine learning algorithms or APIs. Some suitable non-limiting examples of the machine learning algorithms or APIs that can be used within the context of one or more embodiments of the present invention include Natural Language Understanding API, Tone Analyzer API, Visual Recognition API and/or Natural Language Classifier API provided by IBM Watson. Other suitable cognitive based algorithms or techniques may be used such that a nature of a conversation or text found in the captured portions of the given time period may be ascertained.

In some embodiments of the present invention, review generation component 402 is configured to compare audio data of the captured portions with a voiceprint of the user to verify that the audio data of the captured portions originate from the user. In some embodiments of the present invention, sentiment analysis component 414 is configured to perform sentiment analysis on the captured portions only if the audio data of the captured portions is verified as originating from the user.

Review generation component 402 is configured to generate and/or update a review of the product or service at the completion of each time period of the series of time periods, in which the generating and/or updating of the review includes generating a rating score for each time period of the series of time periods, and generating and/or updating an overall rating score for the series of predetermined time periods.

In particular, in some embodiments of the present invention, for each time period in the series of time periods, review generation component 402 is configured to generate a rating score for the given time period based on the sentiment analysis performed on the captured portions of the given time period, and to generate and/or update an overall rating score for the series of predetermined time periods based on the rating score of the given time period.

For example, in some embodiments of the present invention, upon the completion of capturing portions of communication data 406 for a given time period (e.g., identifying a portion of the communication data in which a keyword was detected referenced), review generation component 402 would generate a rating score for the given time period based on the sentiment analysis that was performed on the captured portions of that time period. In some embodiments of the present invention, the output of the sentiment analysis of a given captured portion is a value between −1 and 1, in which values between −1 and 0 are associated with a negative sentiment of the user, and values between 0 and 1 are associated with a positive sentiment of the user. In some embodiments of the present invention, a rating score of the given time period is generated by scaling the outputted value of the sentiment analysis in accordance with a predetermined review rating scale, such as for example, between 1-5 stars (i.e., one-star, two-stars, three-stars, four-stars, five-stars). For example, in some embodiments of the present invention, review generation competent 402 is configured to assign the given time period a rating score of (a) one-star if the outputted sentiment value of the given time period is between about −1.0 and about −0.6; a rating score of two-stars if the sentiment value of the given time period is between about −0.6 and about −0.2; a rating score of three-stars if the sentiment value of the given time period is between about −0.2 and about 0.2; a rating score of fours-stars if the sentiment value of the given time period is between about 0.2 and about 0.6; and a rating score of five-stars if the sentiment value of the given time period is between about 0.6 and about 1.0. Other suitable rating scales may be implemented in accordance with one or more embodiments of the present invention. For example, in some embodiments of the present invention, the outputted semantic value may be scaled to represent whole number values between 0 and 100, or represent grade scores such as A, B, C, D, and F.

In some embodiments of the present invention, if review generation component 402 fails to detect an occurrence of at least one keyword in the communication data of a given time period of the series of predetermined time periods, review generation content 402 may generate a neutral review of the product or service for the time period, in which the neutral review is generated without performing sentiment analysis on the communication data that was obtained for the given time period. In some embodiments of the present invention, the neutral review includes a neutral review score, in which the neutral review score is a predetermined default score. For example, in some embodiments of the present invention, the neutral review score is three stars, 50, or the letter “C”. Reporting these neutral reviews can be desirable, in some embodiments of the present invention, as users looking at review data for an item could see what percentage of overall purchasers/users of said product or service felt positive, negative, or neutral. For example, a product with 100 reviews, 80% of which are neutral, 10% positive, and 10% negative. Existing solutions would only show the 10 positive and 10 negative reviews, making the item ratings appear 50% positive and 50% negative. Users looking for certain types of items may be satisfied knowing that a large portion of owners of an item were indifferent, versus requiring a high positive review rating before making a purchase. For example, a user shopping for a toothbrush may see that 90% of users who purchased a given toothbrush never have said anything positive or negative about said toothbrush. This may be enough for the user to feel safe in assuming there are no major flaws or drawbacks with the item.

As noted above, in addition to generating a rating score at the completion of each given time period, review generation component 402 is further configured to generate and/or update an overall rating score at the completion of each given time period, which takes into consideration the rating score that was created for the given time period as well as any rating scores that were generated for any prior time periods. For example, at the completion of a first time period of the series of predetermined time periods, review generation component 402 generates a rating score for the first time period and then generates an overall rating score for the product or service. At the completion of a second time period of the series of predetermined time periods, review generation component 402 generates a rating score of the second time period and then updates the overall rating score based on the rating score of the second time period.

For example, if three time periods have been processed, at the completion of the third time period, review generation competent 402 would generate a rating score for the third time period, as well as update a prior generated overall rating score, in which the prior generated overall rating score is then updated based on the rating score of the third time period (e.g., updating the overall rating score such that the overall rating score is based on a combination of the rating score of the first period, the rating score of the second period, and the rating score of the third period).

In some embodiments of the present invention, the overall rating score is ascertained by averaging the rating scores of all the time periods that have been processed so far. For example, in some embodiments of the present invention, if three time periods have been processed so far, review generation component 402 would then obtain the overall rating score that was generated at the second period and then update the overall rating score based on the rating of the third time period. In some embodiments of the present invention, if only one time period of the series of time periods have bene processed so far (or if the series of time periods only has one time period), the overall rating score may be the same as the rating score of the first time period.

In some embodiments of the present invention, the overall rating score is a weighted average score that is based on the rating score of the given time period and any rating scores that were generated for any previous time periods of the series of predetermined time periods, in which the given time period is assigned a higher weight as compared to weights of the previous time periods of the series of time periods. For example, at the completion of a fourth period of time, an overall rating score may be generated that takes into consideration the rating scores of the first, second, third, and fourth time periods, in which the rating score of the fourth time period is weighted higher than the rating scores of the first, second and third time periods.

In some embodiment of the present invention, the review that is generated and/or updated at the completion of each time period of the series of predetermined time period includes the rating score of the given time period, the overall rating score of the time periods that have been processed, as well as a time stamp that is associated with the given time period. In some embodiments of the present invention, the review that is generated and/or updated at the completion of each time period of the series of predetermined time periods further includes a snippet of the captured portions that are associated with the given time period. For example, in some embodiments of the present invention, the review that is generated and/or updated includes a snippet of audio data and/or a text data that was obtained in the captured portion.

In some embodiments of the present invention, once all the time periods of the series of time periods have been processed, a final review of the product or service is generated for the user (e.g., product or service review 404), in which final review includes the rating score that was generated for each time period of the series of time periods, as well as includes the overall rating score of the series of predetermined time periods. The final review is then stored, transmitted, and/or published by review generation component 402. In some embodiments of the present invention, review generation component 402 is configured to transmit the final review to one or more systems and/or users, such as for example, transmitting the final review over a communication network to a product or service provider, and/or transmitting the final review over a communication network to a computing device associated with the user. In some embodiments of the present invention, the final review is published to an online platform such as, for example, a streaming service or online marketplace.

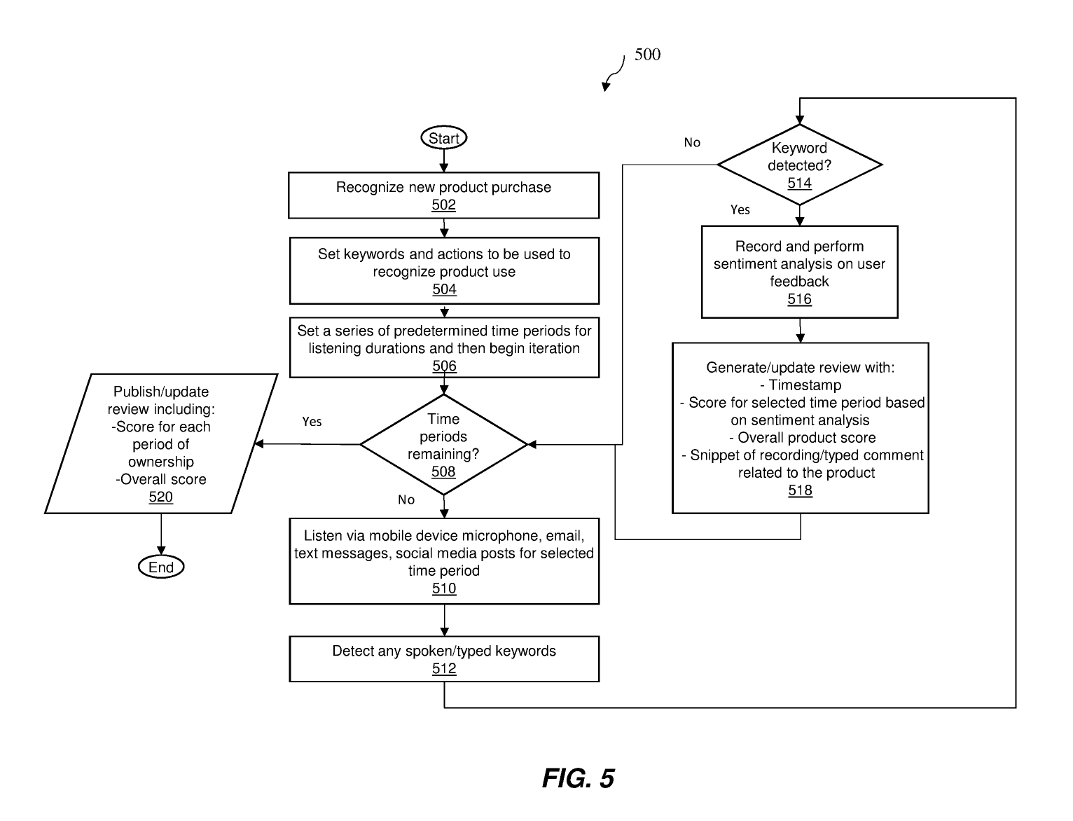

FIG. 5 depicts one example of a process flow 500 that can be implemented by system 400 of FIG. 4 in accordance with one or more embodiments of the present invention. In particular, process flow 500 describes the performance of steps in a manner similar to the functions identified above in regards to FIG. 4, in the context of a purchase of a product by a user. As shown in FIG. 5, at 502 a new purchase of a product is recognized. At 504, a set of keywords and/or actions to be used to recognize the product in communication data of the user is generated. At 506, a series of predetermined time periods are set that establish listening durations and iteration points. At 508, a determination is made as to if all the time periods in the series of predetermined time periods have been processed (e.g., performing steps 510, 512, 514, 516, and 518 for each time period in the series of predetermined time periods). If all of the time periods of the series of predetermined time periods have not yet been processed, at 510 then a next remaining time period in the series of time periods is selected and then communication content associated with the selected time period is passively collected (e.g., obtaining audio from a microphone of a mobile device associated with the user, obtaining email of the user, obtaining text messages of the user, obtaining social media posts of the user, etc.). At 512, occurrences of keywords are detected in the communication data of the user (e.g., detecting whether certain words are spoken and/or type by the user). At 514, a determination is made as to if a keyword was detected in the communication data of the selected time period. If a keyword was detected in the communication data, then at 516 a portion of the communication data is recorded and sentiment analysis is performed on the portion to obtain indirect user feedback data regarding the product. At 518, a review of the product is generated and/or updated for the selected time period, in which the generated and/or updated review includes (a) a timestamp associated with a particular time when a keyword was detected in the communication data of the selected time period, (b) a rating score for the selected time period, in which the rating score is based on sentiment analysis of the selected period, (c) an overall product rating score that is generated and/or updated based on the rating score of the selected time period; and (d) a snipped portion of the communication data that corresponds with the time stamp. After generating and/or updating a review of the product at 518, if at 508 a determination is made that all of the time periods of the series of predetermined time periods have been processed, then at 520 the generated review is finalized and then stored, published, and/or transmitted, in which the final review of the product includes the rating score of each selected time period and the overall product rating score of the series of predetermined time periods.

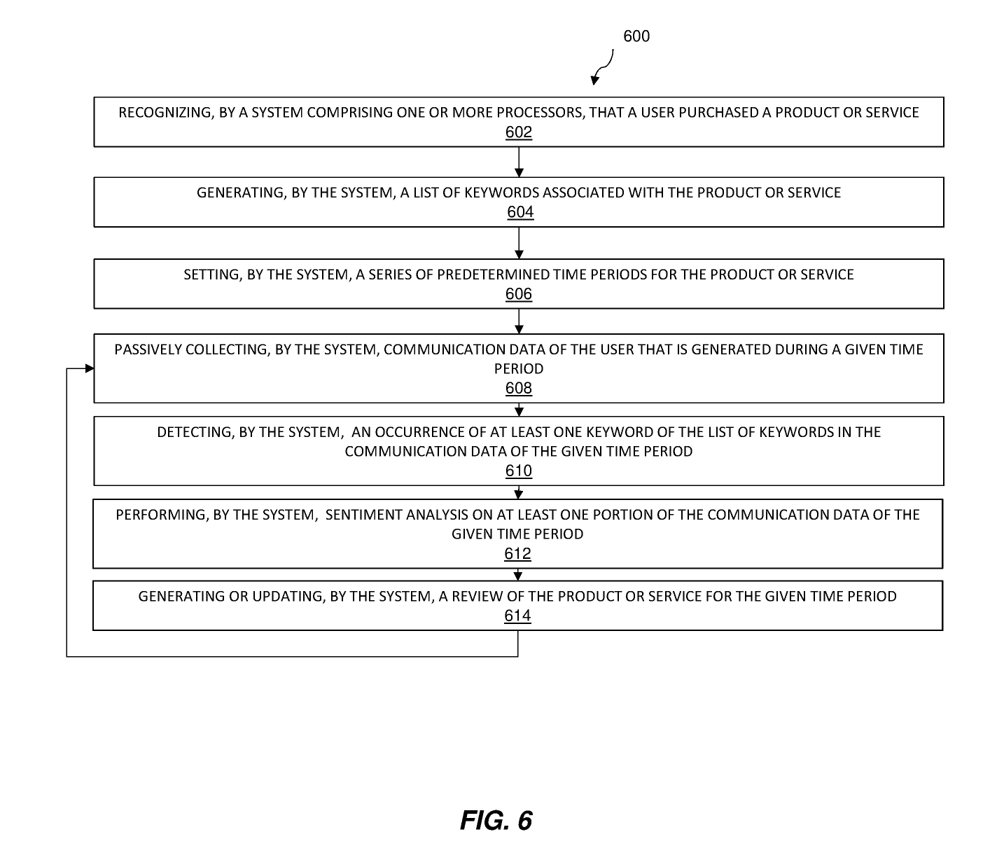

Additional details of the operation of system 400 will now be described with reference to FIG. 6, wherein FIG. 6 depicts a flow diagram illustrating a methodology 600 according to one or more embodiments of the present invention. At 602, a user's purchase of a product or service is recognized. At 604, a list of keywords associated with the product or service is generated. At 606, a series of predetermined time periods is set for the product or service. At 608, communication data of the user that is generated during a given time period of the series of time periods is passively collected. At 610, an occurrence of at least one keyword of the list of keywords is detected in the communication data of the given time period. At 612, sentiment analysis is performed on at least one portion of the communication data of the given time period. At 615, a review of the product or service is generated and/or updated for the given time period. Steps 608-614 are then repeated for each remaining time period of the series of predetermined time periods.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for automatically generating a user review of an item without requiring user action, the computer-implemented method comprising:
recognizing, by a system comprising one or more processors, that a user purchased an item;
after recognizing that the user purchased the item, generating, by the system, a list of keywords associated with the item for recognizing when the user is passively providing feedback regarding the item;
setting, by the system, a series of predetermined time periods for the item, wherein each time period, of the series of predetermined time periods, represents a different respective length of ownership of the item; and
for each time period in the series of predetermined time periods:
passively collecting, by the system, communication data of the user that is generated during the time period;
detecting, by the system, an occurrence of at least one keyword of the list of keywords in the communication data of the time period;
in response to detecting an occurrence of at least one keyword, performing, by the system, sentiment analysis on at least one portion of the communication data of the time period; and
generating or updating, by the system, a review of the item, wherein generating or updating the review of the item includes:
generating, by the system, a rating score for the time period based on the sentiment analysis; and
generating or updating, by the system, an overall rating score for the series of predetermined time periods based on the rating score of the time period.

2. The computer-implemented method of claim 1, wherein the communication data includes audio data that is generated by a microphone of a computing device associated with the user.

3. The computer-implemented method of claim 2, wherein passively collecting communication data of the user that is generated during the time period comprises:
obtaining the audio data that is generated by the microphone during the period of time; and
extracting text from the obtained audio data by transcribing the audio data.

4. The computer-implemented method of claim 3, wherein performing sentiment analysis on at least one portion of the communication data of the time period includes performing sentiment analysis on at least one portion of the extracted text.

5. The computer-implemented method of claim 2, wherein the computer-implemented method further includes:
comparing audio data of the at least one portion with a voiceprint of the user to verify that the audio data of the at least one portion originates from the user, wherein the sentiment analysis is performed on the at least one portion only if the audio data of the at least one portion is verified to originate from the user.

6. The computer-implemented method of claim 1, wherein the computer-implemented method further includes:
in response to failing to detect an occurrence of at least one keyword in the communication data of the time period, generating a neutral review of the item for the time period, wherein the neutral review is generated without performing sentiment analysis on the communication data of the time period.

7. The computer-implemented method of claim 1, wherein generating or updating an overall rating score includes calculating a weighted average score based on the rating score of the time period and any rating scores that were generated for any previous time periods of the series of predetermined time periods, wherein the time period is assigned a higher weight as compared to weights of the previous time periods of the series of time periods.

8. A system for automatically generating a user review of an item without requiring user action, the system comprising one or more processors configured to perform a method comprising:
recognizing, by the system, that a user purchased an item;
after recognizing that the user purchased the item, generating, by the system, a list of keywords associated with item for recognizing when the user is passively providing feedback regarding the item;
setting, by the system, a series of predetermined time periods for the item, wherein each time period of the series of predetermined time periods represents a different respective length of ownership of the item; and
for each time period in the series of predetermined time periods:
passively collecting, by the system, communication data of the user that is generated during the time period;
detecting, by the system, an occurrence of at least one keyword of the list of keywords in the communication data of the time period;
in response to detecting an occurrence of at least one keyword,
performing, by the system, sentiment analysis on at least one portion of the communication data of the time period; and
generating or updating, by the system, a review of the item, wherein generating or updating the review of the item includes:
generating a rating score for the time period based on the sentiment analysis; and
generating or updating an overall rating score for the series of predetermined time periods based on the rating score of the time period.

9. The system of claim 8, wherein the communication data includes audio data that is generated by a microphone of a computing device associated with the user.

10. The system of claim 9, wherein passively collecting communication data of the user that is generated during the time period comprises:
obtaining the audio data that is generated by the microphone during the time period; and
extracting text from the obtained audio data by transcribing the audio data.

11. The system of claim 10, wherein performing sentiment analysis on at least one portion of the communication data of the time period includes performing sentiment analysis on at least one portion of the extracted text.

12. The system of claim 9, wherein the method further includes:
comparing audio data of the at least one portion with a voiceprint of the user to verify that the audio data of the at least one portion originates from the user, wherein the sentiment analysis is performed on the at least one portion only if the audio data of the at least one portion is verified to originate from the user.

13. The system of claim 8, wherein the method further includes:
in response to failing to detect an occurrence of at least one keyword in the communication data of the time period, generating a neutral review of the item for the time period, wherein the neutral review is generated without performing sentiment analysis on the communication data of the time period.

14. The system of claim 8, wherein generating or updating an overall rating score includes calculating a weighted average score based on the rating score of the time period and any rating scores that were generated for any previous time periods, of the series of predetermined time periods, wherein the time period of the series of time periods is assigned a higher weight as compared to weights of the previous time periods of the series of time periods.

15. A computer program product for automatically generating a user review of an item without requiring user action, the computer program product comprising a computer readable storage medium having program instructions embodied therewith, the program instructions executable by a system comprising one or more processors to cause the system to perform a method comprising:
recognizing, by the system, that a user purchased an item;
after recognizing that the user purchased the item, generating, by the system, a list of keywords associated with the item for recognizing when the user is passively providing feedback regarding the item;
setting, by the system, a series of predetermined time periods for the item, wherein each time period, of the series of predetermined time periods, represents a different respective length of ownership of the item; and
for each time period in the series of predetermined time periods:
passively collecting, by the system, communication data of the user that is generated during the time period;
detecting an occurrence of at least one keyword of the list of keywords in the communication data of the time period;
in response to detecting an occurrence of at least one keyword, performing sentiment analysis on at least one portion of the communication data of the time period; and
generating or updating a review of the item, wherein generating or updating the review of the item includes:
generating a rating score for the time period based on the sentiment analysis; and
generating or updating an overall rating score for the series of predetermined time periods based on the rating score of the time period.

16. The computer program product of claim 15, wherein the communication data includes audio data that is generated by a microphone of a computing device associated with the user.

17. The computer program product of claim 16, wherein passively collecting communication data of the user that is generated during the time period comprises:
obtaining the audio data that is generated by the microphone during the time period; and
extracting text from the obtained audio data by transcribing the audio data.

18. The computer program product of claim 17, wherein performing sentiment analysis on at least one portion of the communication data of the time period includes performing sentiment analysis on at least one portion of the extracted text.

19. The computer program product of claim 16, wherein the method further includes:
comparing audio data of the at least one portion with a voiceprint of the user to verify that the audio data of the at least one portion originates from the user, wherein the sentiment analysis is performed on the at least one portion only if the audio data of the at least one portion is verified to originate from the user.

20. The computer program product of claim 15, wherein generating or updating an overall rating score includes calculating a weighted average score based on the rating score of the time period and any rating scores that were generated for any previous time periods of the series of predetermined time periods, wherein the time period of the series of time periods is assigned a higher weight as compared to weights of the previous time periods of the series of time periods.
